(19) United States
(12) Patent Application Publication
(10) Pub. No.: US 2018/0284956 A1
(43) Pub. Date: Oct. 4, 2018

(54) FRAGMENTATION AND MESSAGING ACROSS WEB APPLICATIONS

(71) Applicant: SAP SE, Walldorf (DE)

(72) Inventors: Roman ROMMEL, Neustadt an der Weinstrasse (DE); Vladimir SHAPIRO, Sinsheim (DE)

(21) Appl. No.: 15/477,892

(22) Filed: Apr. 3, 2017

(51) Int. Cl. G06F 3/0482; G06F 3/0486; G06F 9/54

(52) U.S. Cl. CPC G06F 3/0482; G06F 9/546; G06F 3/0486

(57) ABSTRACT

Disclosed herein are embodiments for modular fragmentation and seamless data transfer across different web applications, for improved user experience. An example system may load a first web application, with corresponding data, in a web browser window, displaying output of the first web application. The system may further display a plurality of elements each corresponding to a separate entry of the data corresponding to the first web application in the web browser. The system includes a web application floorplan configured to allow at least one type of modular operation of a selected element of the plurality of elements, and execute the modular operation of the selected element. The modular operation may be a fragmentation action or a cross-application messaging action, which may include a docking or undocking operation of a selected web application component, or a drag-and-drop operation of a selected element between different web applications in different web browser windows.

### BACKGROUND

Modern graphical user interfaces (GUIs) for native desktop applications have long employed frameworks allowing for intuitive handling of GUI elements from one application to another. For example, in a native desktop environment, a window containing an element such as a toolbar may allow a user to detach the toolbar as a separate window. Similarly, icons representing files, or other data fields, may be easily moved from one window to another window for certain applications in a native desktop environment.

By contrast, web applications have lacked such flexible and intuitive functionality. Rather, web applications have been limited to the narrow confines of web browsers, which do not enable web applications to behave like native applications, even if the browser itself internally supports similar intuitive GUI features as a native application. Even native applications have lacked such features as decomposing entire application components into separate applications, as compared with to only undocking toolbars or other simple assets.

Historically, web applications tended to be passive on the side of clients (web browsers), with any dynamic content or actions in response to users being generated in response to a simple query and returned to the user. Modern web applications, however, have gradually evolved to offload more effects and functionality to clients as the clients have become increasingly powerful with respect to processing, storage, display functionality, etc. As modern web applications evolve, so will the expectations of users to have intuitive and flexible user interface features, so as to provide consistent and convenient user experiences comparable to what users have enjoyed of native applications in desktop environments.

### BRIEF DESCRIPTION OF THE DRAWINGS

The accompanying drawings are incorporated herein and form a part of the specification.

FIG. 1 is an example simulated graphical user interface (GUI) demonstrating cross-application messaging with drag-and-drop functionality between two different web applications, according to some embodiments.

FIGS. 2A-2D represent an example GUI demonstrating web application fragmentation, focusing on an undocking operation, according to some embodiments. In particular:

FIG. 2A illustrates an undocking operation in which a specific component, of a web application having multiple components, is being undocked, according to an example embodiment. For illustrative purposes, to show this undocking operation in a single drawing, an arrow traces the movement of a map component 208. Such an arrow is not necessarily shown in an actual GUI display.

FIG. 2B shows a state of the web application of FIG. 2A before the undocking operation, according to an example embodiment.

FIG. 2C shows a state of the web application of FIG. 2A after the undocking operation, according to an example embodiment. The state shown in FIG. 2C may be an intermediate state of the web application before proceeding to the state shown in FIG. 2D.

FIG. 2D shows a state of the web application of FIG. 2A after the undocking operation or after an intermediate state such as that shown in FIG. 2C, according to an example embodiment.

FIG. 3 shows a flowchart illustrating a process for cross-application messaging, according to an example embodiment.

FIG. 4 shows a flowchart illustrating a process for web application fragmentation, according to an example embodiment.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for fragmentation and messaging across web applications.

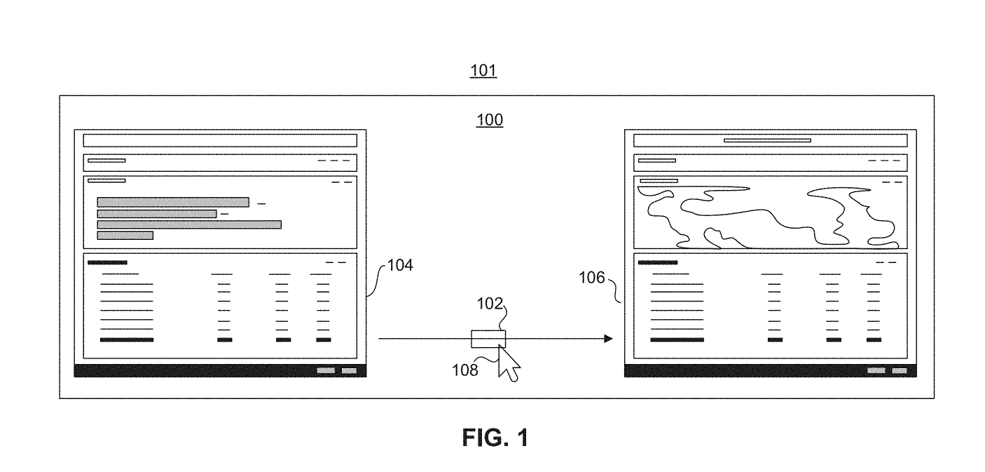

FIG. 1 is an illustration of an exemplary graphical user interface (GUI) having support for cross-application messaging in web applications, according to an example embodiment. Depicted in FIG. 1 is the visible area of a GUI display 100 on a computing device 101. In this exemplary embodiment, a graphical element 102 is found in a first web application 104. Additionally, a second web application 106 is present and currently appears in the GUI display 100.

In an embodiment, the first web application 104 is a different web application from the second web application 106. These different web applications 104 and 106 may be of entirely different types and functionalities, or they may be of similar types or have similar functionalities. Alternatively, the web applications need not be different. In other embodiments, both web applications may be separate instances of the same web application, or may be fragmented components of one instance of a web application.

In this non-limiting example, cross-application messaging across web applications may be demonstrated by a user's action of dragging and dropping the graphical element 102 from the first web application 104 to the second application 106. The graphical element 102 may be a modular graphical element capable of being displayed anywhere in the display 100, such as in a web browser, as permitted by either web application 104 or 106.

For clarity, in FIG. 1, this action is shown by way of a cursor 108 engaged in a drag-and-drop action, in an exemplary embodiment. The cursor 108 may represent a position of a pointing device, such as a hardware mouse, joystick, pointing stick, pressure sensor, trackball, touchpad, or other motion-tracking device as understood in the art. However, the cursor 108 is optional, and is not necessary when used with other pointing devices such as a touchscreen or similar device, which may be accompanied by a stylus.

In other examples, the same result may be accomplished without graphical or tactile interaction of the user with the GUI display or pointing device. In other words, a drag-and-drop action is not specifically needed in all embodiments of cross-application messaging. For example, a cross-application messaging event such as moving the graphical element 102 from the first web application 104 to the second web application 106 may be effected by way of a voice command, a gesture, accelerometer input, infrared port, wireless signal (including Bluetooth, NFC, RFID, WI-Fi, etc.), a script, a command-line interface (CLI), a terminal, textual, or text-based user interface (MI), an external device such as via a serial interface (e.g., RS-232, USB, IEEE 1149, IEEE 1394, PCIe, DisplayPort, etc.), or through a separate application programming interface (API).

Other graphical representations of moving the graphical element 102 from the first b application 104 to the second web application 106, such as animations, trails, flashing, or color inversion, to name some non-limiting examples, may optionally accompany the cross-application messaging shown here.

Regarding implementation details, the cross-application messaging here, which allows for exchange of information across web applications, may be implemented atop existing web GUI frameworks or floorplans supporting exchange of portable data, such as in standard formats of XML or JSON, or structured or unstructured text or binary data files or steams, to name some non-limiting examples, and the desired actions for exchanging such data, such as drag-and-drop, gestures, or other commands, to name further non-limiting examples.

In one illustrative example, a first web application such as the first web application 104 may have an entire list of data entries, each rendered as a graphical element such as the graphical element 102. The list of data entries rendered may have been read from a stream or file containing the entire list, for example, in JSON format. Each graphical element 102 may be designated as draggable by the first web application 104.

In a second web application such as the second web application 106, there may be a space designated as a drop zone or a droppable area, into which a graphical element may be dragged. Once graphical element 102 is dropped in the drop zone or droppable area of the second web application 106, the same data corresponding to the graphical element 102 as originally shown in the first web application 104 may now be shown in the second web application 106, as part of a displayed list in the second web application 106. The list copied to the second web application 106 may contain the entire list of the first web application 104, only displaying the data corresponding to the dropped elements. Alternatively, the list as displayed in the second web application 106 may include only the data corresponding to the dropped elements, thus forming a subset of the list of the first web application 104.

The graphical element 102 that has been dragged from the first web application 104 to the second web application 106 may disappear from the first web application 104, as a unique element that may only be displayed in one application at once. Alternatively, the graphical element 102 may still remain in the first web application 104 as part of a master list, and may remain displayed in the first web application 104 even after it has been moved to and displayed in the second web application 106, and this process may be repeated multiple times, such that the same graphical element 102 may be dragged and dropped again into the second web application 106, either to be ignored as redundant, or to be entered as a separate (duplicated or uniquely modified) entry in the displayed list of the second web application 106.

In an embodiment, the list displayed in the second web application 106 may be stored in a cache only, or alternatively may also be stored in persistent storage or long-term storage, locally or remotely. Depending on the expected functionality of the first web application 104 and/or second web application 106, the cross-application messaging may or may not result in permanent changes on the side of either web application or both web applications.

By way of another example, the computing device 101 may include, but is not limited to, a mobile phone or other mobile device, a personal digital assistant (PDA), a computer, a cluster of computers, a set-top box, a smart watch, a smart phone, a tablet, or other types of device capable of processing instructions and receiving and transmitting data to and from humans and other computing devices. Cross-application messaging may allow additional configurations for improvements in user experience on touch-screen devices accordingly.

In some embodiments, cross-application messaging may work across multiple types of devices, e.g., where the first web application 104 is on a desktop computer and the second web application 106 is on a mobile device, either in an independent mode for each device, or in a converged mode for at least two devices. In such embodiments, alternative means of moving data objects, such as gestures, commands, vocal instructions or voice commands, to name a few non-limiting examples, may be used for cross-device cross-application messaging or cross-device application fragmentation. Further, in such embodiments, cross-application messaging or application fragmentation may work on the same display or across multiple displays.

In some embodiments, the computing device 101 may include user interface (UI) controller 108 for processing output provided by applications, such as web browsers, which execute web applications 104 and 106. For the purposes of this disclosure, display 100 may be a virtual representation of a web browser window, for example. Alternatively, display 100 may be the output of an interactive terminal screen, which may be viewed on devices such as CRT, plasma, LCD, or OLED monitors or touch screens, in some exemplary embodiments. However, a “display” generally may be any kind of output device, including a printer, speaker, screen reader, signaling device, serial port, or any other output device.

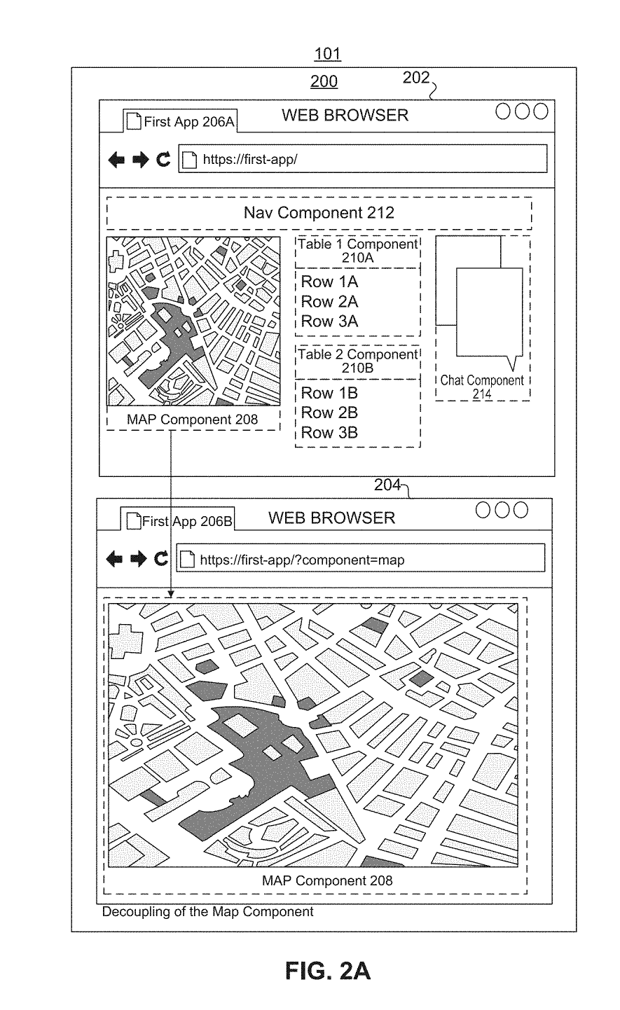

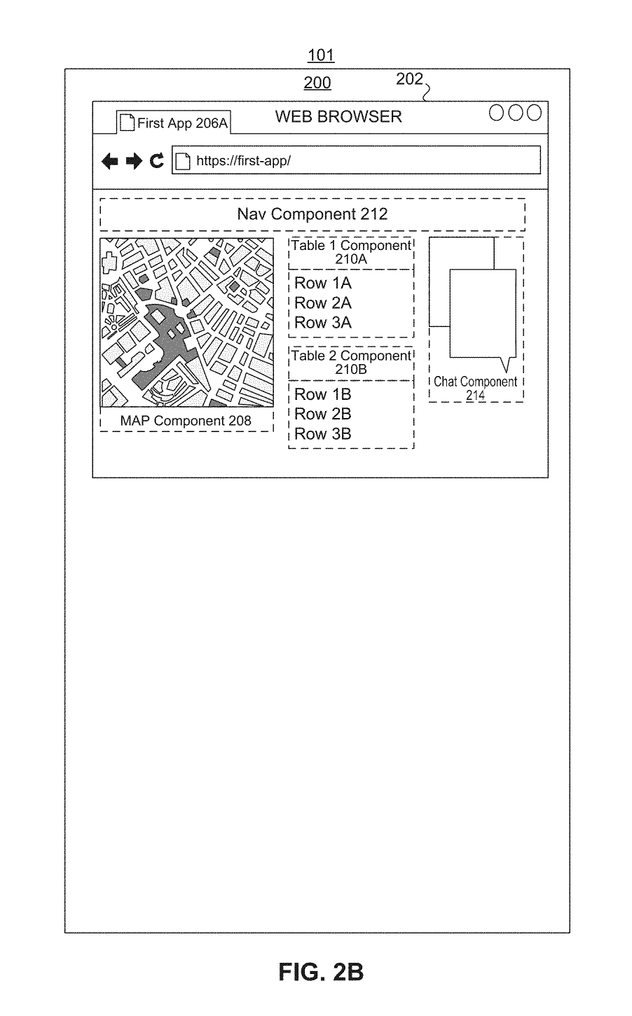

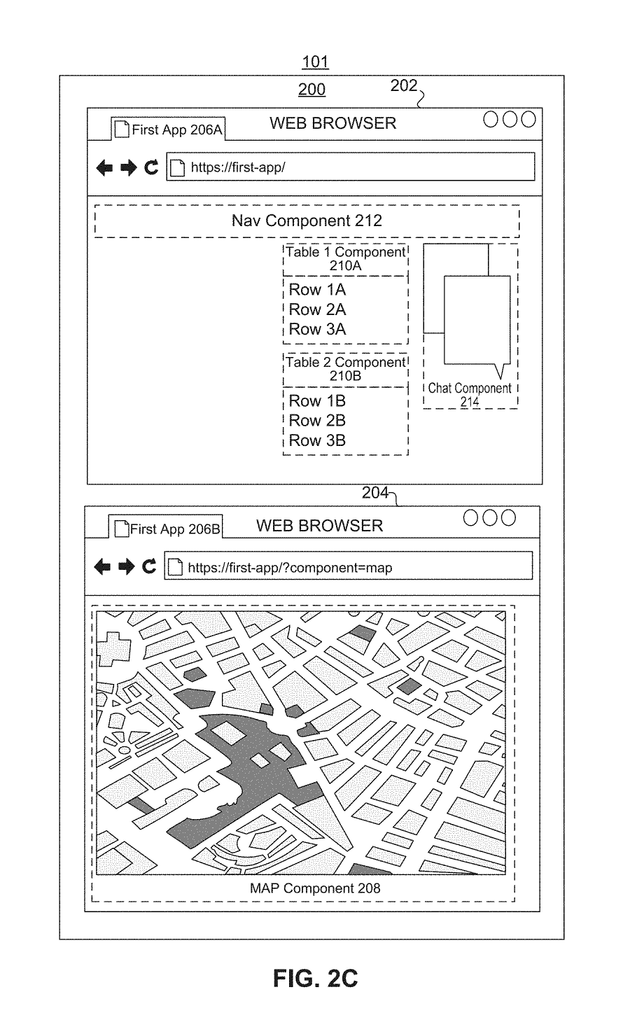

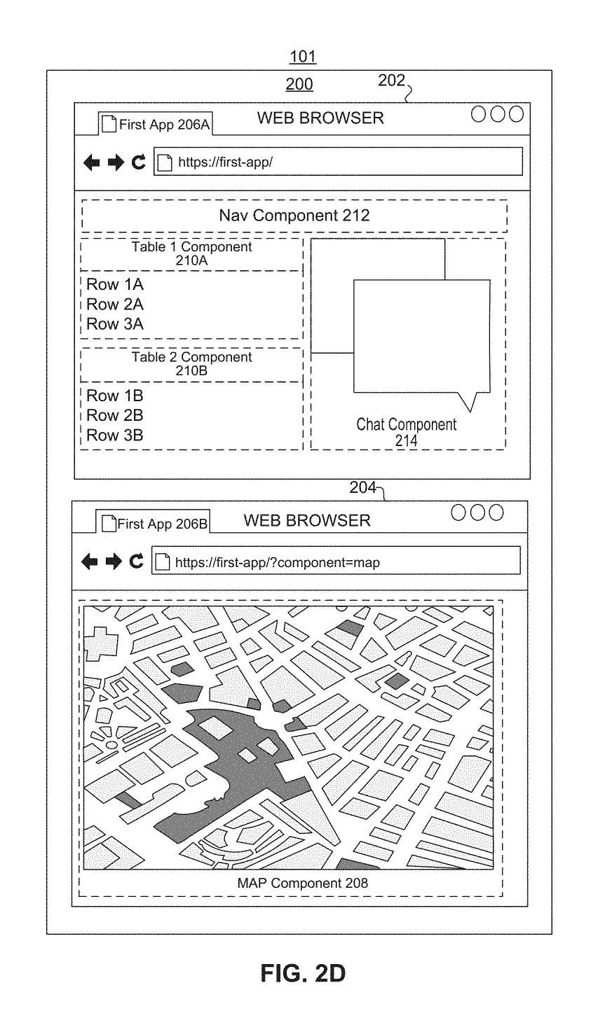

FIGS. 2A-2D are illustrations of an example GUI showing a web application floorplan or framework supporting fragmentation of components, according to an example embodiment. Each of these figures shows a display 200 on computing device 101. In some embodiments, display 200 may be a different physical or logical display from display 100 of FIG. 1.

In FIG. 2A, a first web browser instance 202 may execute and/or render a first web application instance 206A. In this exemplary embodiment, the first web application instance 206A is displayed in a tab of a tabbed web browser, although any variation of the display or browser layout may be used with the current floorplan or framework, including full-window displays of the first web application instance in the web browser, tiled displays of the first web application instance 206A in any separate application, or full-screen display of the first web application instance 206A occupying all of display 200, to name a few non-limiting examples that may alternatively be implemented in accordance with this specification.

Within the first web application instance 206A executing within the first web browser instance 202, any number of components may be arranged. In the example of FIG. 2A, the components 208, 210A, 210B, 212, and 214 are laid out in a tiled arrangement within the visible window of the first web browser instance 202. However, other configurations or arrangements are possible, such as a stacked or tabular view of the components, which may or may not be entirely visible within the window of the first web browser instance 202.

The first web browser instance 202 and/or the first web application instance 206A may allow scrolling within the window of the first web browser instance 202 as necessary to view all components. Scrolling may be achieved by scroll bars or virtual knobs or buttons on the sides of window of the first web browser instance 202, or via gestures, commands, or similar input from another user or program via a GUI, CLI, TUI, or API.

For purposes of the examples depicted in FIGS. 2A-2D, map component 208 is shown as being undocked from the first web application 206A. However, the component to be undocked, as well as docked or redocked, may be any type of component having any functionality, not in any way limited to any of the components shown in FIGS. 2A-2D.

In an undocking operation, as shown in this example, map component 208 is moved or copied from the first web application instance to a location in display 200 beyond the window of the first web browser instance 202. As a result, a second web browser instance 204 may appear, containing a second web application instance 206B. The second web application instance 206B may be the same underlying web application as executed in the first web application instance 206A, or it may be a different underlying web application using the same (or compatible) framework described in this specification.

The downward arrow shown in FIG. 2A demonstrates the movement of the map component 208, for illustrative purposes, and it is not necessarily displayed in an actual GUI or display 100. Similarly, in FIG. 2A, the map component 208 is shown in two places at once, demonstrating the movement from the first web browser instance 202 to the second web browser instance 204. However, it is not necessary in an actual GUI or display 100 for a moved element such as map component 208 to be displayed in two locations at once. For example, map component 208 may move singularly, such as is shown in a transition between FIG. 213 and FIG. 2C. Alternatively, as described below with FIG. 2D, an element such as map component 208 may be copied and mirrored, or copied and independently operated as a separate instance of the underlying map component 208.

The undocking operation may also be achieved by scroll bars or virtual knobs or buttons on the sides of window of the first web browser instance 202, or via gestures, commands, or similar input from another user or program via a GUI, CLI, TUI, or API. Here, a gesture may include a drag-and-drop, a flick, or a multi-touch gesture such as a pinch, spread, or similar technique employed on a touch-screen interface, to name a few non-limiting examples.

Movement of map component 208 is shown in 2A by an arrow, for illustrative purposes, to show this undocking operation in a single drawing, wherein the arrow traces the movement of a map component 208. However, such an arrow is not necessarily shown in an actual GUI display as may be implemented.

Once the undocking operation is complete, the result may be that the map component 208 fully occupies the viewable space of the second web application instance 206B in the second web browser instance 204. Alternatively, the map component 208, with or without the second web application instance 206B, may appear to stand alone, without any visible or manipulatable window decorations corresponding to a web browser per se.

Additionally, once the undocking operation is complete, the original display of map component 208 may remain in its original position of the first web application instance 206A. Alternatively, in a different configuration of the same embodiment, or in a different, separate embodiment, the original position of map component 208 may become vacant after the map component has been undocked by way of the undocking operation. Further, following a vacancy in the place of an undocked component, any remaining components in the same first web application instance 206A may expand to fill the newly emptied space. These alternative embodiments or configurations are shown by way of example in FIGS. 2C and 2D, as described below.

FIG. 2B shows an initial state of the first web browser instance 202 and first web application instance 206A, with multiple components 208-214, before an undocking operation is performed. Here, the components 208, 210A, 210B, 212, and 214 are laid out in a tiled arrangement within the visible window of the first web browser instance 202. However, other configurations or arrangements are possible, such as a stacked or tabular view of the components, which may or may not be entirely visible within the window of the first web browser instance 202.

FIG. 2C shows a result of a completed undocking operation, after which a vacant space is left in the visibly displayed output of the first web application instance 206A as a result of the undocking operation. Here, the remaining components of the first web application instance 206A remain where they originally were when the map component 208 was still docked in the first web application instance 206A prior to the undocking operation.

FIG. 2D shows a result of a completed undocking operation, after which the space originally occupied by map component 208 in the first web application instance 206A becomes filled by at least one of the remaining components in the first web application instance 206A as a result of the undocking operation. By way of further description, the state of the layout of components 210A, 210B, 212, and 214 in the first web application instance 206A as shown in FIG. 2D may immediately follow the state shown in any of FIGS. 2A-2C.

For example, at an initial time (t=0), display 200 may appear as shown in FIG. 2B. Upon successful completion of an undocking operation, at a next point in time (t=1), the resulting display 200 may appear as shown in FIG. 2A, with map component 208 showing as a small component among multiple components in the first web application instance 206A together on display 200 with the second web application instance 206B, which may exclusively contain a copy of the map component 208. The second copy of the map component 208 in the second web application instance 20613 may keep the same state as the first copy of the map component 208 in the first web application instance 206A, e.g., always showing the same map at all times. Alternatively, the second copy of the map component 208 in the second web application instance 206B may operate independently of the first copy of the map component 208 in the first web application instance 206A, e, g., thus allowing different map views to be displayed simultaneously.

As an alternative example, at the next point in time (t=1) after the initial time (t=0), the first web application instance 206A may appear as it does in FIG. 2C. At a further point in time (t=2), the first web application instance 206A may maintain the arrangement of components as they were at time t=1. Alternatively, at the further point in time (t=2), the arrangement of components in the first web application instance 206A may be arranged as appears in FIG. 2D.

For the purposes of these exemplary embodiments, times t=0, t=1, and t=2 may be arbitrary points in time, sequentially arranged, with arbitrary temporal spacing. For example, the time between points t=0 and t=1 need not be equal to the time between t=1 and t=2.

In some embodiments, the transition from the display of FIG. 2C to the display of FIG. 2D between the times of t=1 to t=2 may involve a smooth transition, such as an animated sliding, scaling, or other related transitional animation of the remaining components 210A, 210B, 212, and/or 214 moving to fill the vacant space left in the place of the original map component 208.

In some embodiments, such transitions may involve changes in the shape, size, or aspect ratio of at least one of the remaining components in the first web application instance. Additionally, other attributes of at least one of the remaining components may also change, such as color, sound, video playback, activity, or other corresponding behavior of any of the remaining components.

In a web browser underlying a web application having fragmented or fragmentable components, some or all of the components may run in the web browser, with separate or shared runtime data in cache, independently of any particular web browser window instance. Such independent back-end execution allows for seamless docking, undocking, redocking, or other modular fragmentation actions, allowing for a user easy creation, destruction, or dismissal of windows, to work transparently on a front end visible to a user, for improved user experience when using web applications.

In the case of fragmentation of components for web applications, such a flexible interface allows for multi-window user interfaces in web applications, rivaling powerful features of native desktop applications not yet seen in the web application space. A feature of this fragmentation is that any or all components may be docked, undocked, or redocked, attached, detached, coupled, or decoupled, etc.; fragmentation need not be limited to any particular component as a matter of technical simplicity or other such technological limitations. In some embodiments, a component may optionally be designed to be pinned, locked, or otherwise fixed in an instance of a web application or browser window, at the elective discretion of a user or designer.

Additionally, web application fragmentation and cross-application messaging may be combined into the same solution. Such a combination may thus allow for decomposition of web application components into effectively separate applications with seamless data transfer between them. The result of this combination may provide further advantages in the way of simplifying user interfaces for the benefit of users, and thereby improving user experience.

For either of the cross-application messaging or the web application fragmentation features, in some embodiments, separate web applications may run in different framesets, including within iframes in the same web browser instance. For the purposes of this disclosure, multiple separate iframes in the same window of a web browser instance may be considered the same as multiple windows of a web browser.

In some embodiments, application fragmentation may work across multiple types of devices, e.g., where the first web browser 202 is on a desktop computer and the second web browser 204 is on a mobile device, either in an independent mode for each device, or in a converged mode for at least two devices. In such embodiments, alternative means of moving data objects, such as gestures, commands, vocal instructions or voice commands, to name a few non-limiting examples, may be used for cross-device cross-application messaging or cross-device application fragmentation. Further, in such embodiments, cross-application messaging or application fragmentation may work on the same display or across multiple displays.

Additionally, for the purposes of this disclosure, a “window” is not necessarily limited to a rectangular area in a display of a GUI, but may also be virtually represented by a corresponding configuration of box-drawing characters, alphanumeric characters, or other symbolic characters in a TUI, in a menu-driven interface, or other type of user interface, A window may be of any shape or size.

Where different web applications are in different domains, care should be taken in accounting for security risks and countermeasures for cross-origin or cross-site scripting. Web browser conforming to modern standards may block such actions as a rule in the interests of security. However, other custom or standard APIs may allow some degree of messaging between certain applications in different domains or origins. For example, an implementation of the postMessage function of the Web Messaging API may allow cross-application messaging across site domain or origin boundaries without requiring any special security workarounds.

In an exemplary embodiment, implementations of these features may leverage Web Components with features such as Shadow DOM to enable reuse of certain user-interface components, having full functionality and encapsulation with the same code base. Other comparable standards may be used for these purposes as the field of web technology evolves. In another embodiment, for example, the code base may include a combination of Cascading Style Sheets (CSS) and Hypertext Markup Language (HTML) with JavaScript and any compatible data binding frameworks although this example is by no means limited to any of these illustrative options.

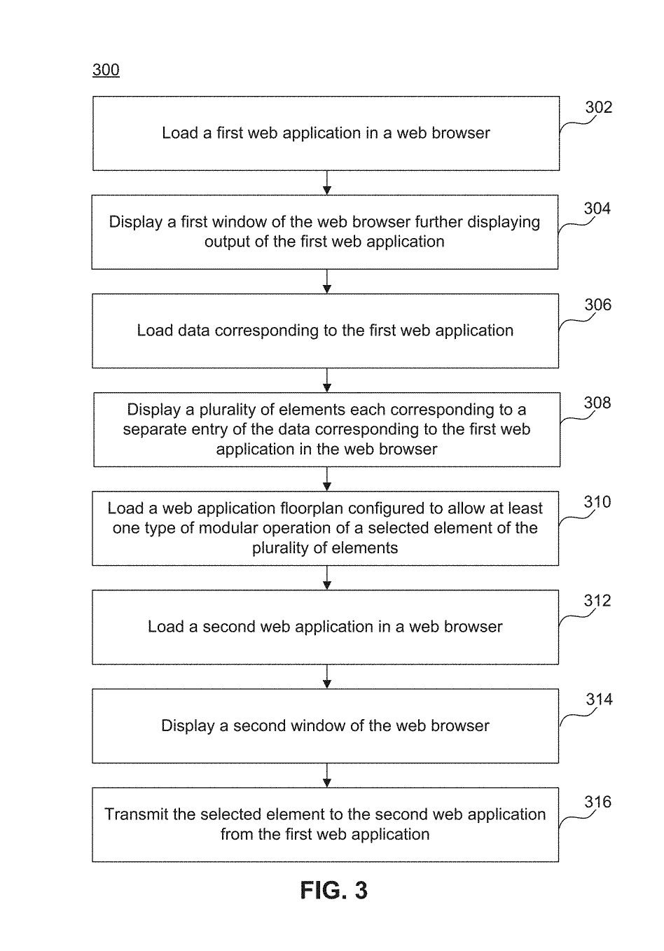

FIG. 3 shows process 300, illustrated by a flowchart illustrating a process for cross-application messaging, and specifically a transmission operation, such as the drag-and-drop operation behaviorally demonstrated in FIG. 1. This process 300 may be used by or for any web application of the embodiments described herein that would have movable (e.g., draggable or droppable) components. Process 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Process 300 shall be described with reference to FIG. 1. However, process 300 is not limited to that example embodiment.

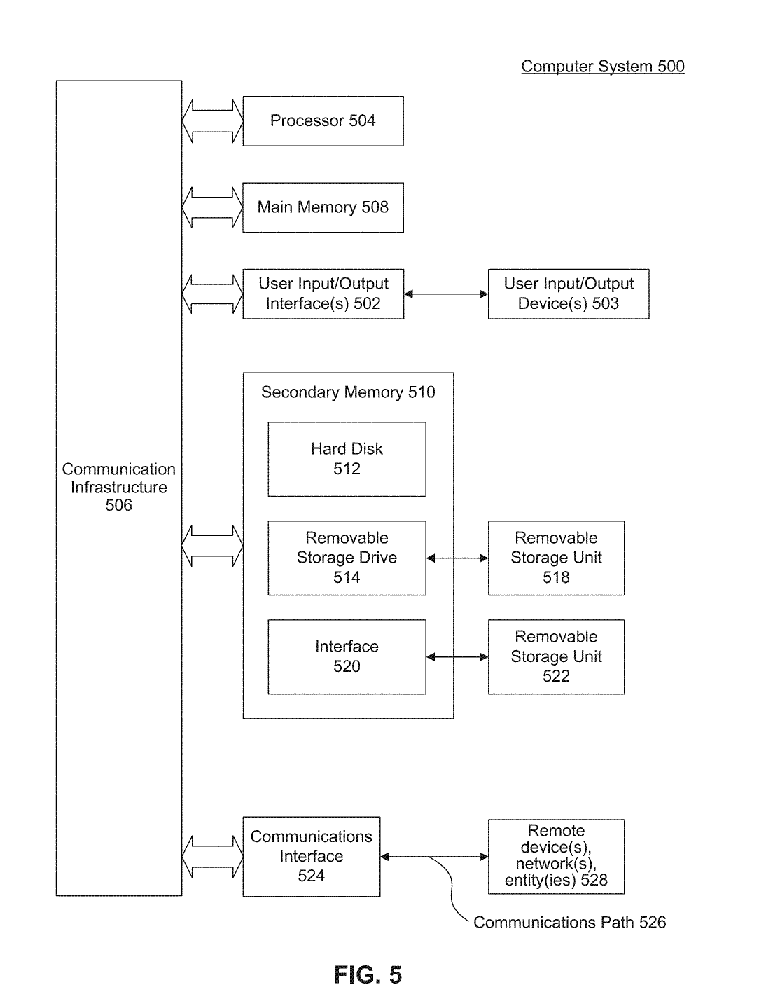

In 302, a processor and memory, such as processor 504 and main memory 508 shown in FIG. 5, may load a first web application, such as element 104 of FIG. 1, in a web browser. The first web application and/or web browser may already be running, including other web pages or applications already in memory, or the first web application and/or web browser may instead be newly installed, initialized, and/or executed for the purpose of running the first web application.

In 304, a first window of the web browser is displayed. The first window of the web browser further displays output of the first web application. In the illustrative embodiment depicted in FIG. 1, each web application may be displayed in its own web browser window, in the same web browser window, in different framesets such as iframes in the same web browser window, etc. In displaying the first window of the web browser, the first window may be newly created for the first web application. In another exemplary embodiment, the first window may already be showing on a display, but in this case, “displaying” the first window will refer to selecting the first window of the web browser in which to proceed with further displaying the visible output of the first web application.

In 306, data corresponding to the first web application may be loaded, such as into memory corresponding to the first web application as allocated through the web browser. In an exemplary embodiment, this data may be meaningful content of the first web application, such as database entries representing, for example, a contacts list, address book, accounting ledger, etc. In the exemplary embodiment shown in FIG. 1, this data may be visually represented by rows of text, charts, maps, etc. In another embodiment, at least some of the data may be code for execution as a separate component of the web application, and data pertaining to that component. Such components may be a map component 208, table components 210A-210B, a chat component 214, etc., such as the components shown in FIGS. 2A-2D.

In 308, a plurality of elements each corresponding to a separate entry of the data corresponding to the first web application may be displayed in the web browser. Here, the elements may be displayed and arranged according to various preferences of an end user, web developer, sitewide stylesheet, or other similar means. In some embodiments, at least one of the elements may be displayed as an independent component of the first web application, which may be docked, undocked, or redocked. In the exemplary embodiment shown in FIG. 1, this data may be visually represented by rows of text, charts, maps, etc. One such element 102 is selected in this illustrative embodiment.

In 310, a web application floorplan may be loaded in such a way as to allow at least one type of modular operation of a selected element of the plurality of elements. This floorplan may be code, such as including various APIs and methods, which provide the web browser and/or web applications with capabilities such as application fragmentation and/or cross-application messaging. In some embodiments, this floorplan may be modular, and may be loaded before, during, or after the loading of the first web application or the web browser into memory. In other embodiments, the floorplan may be integrated with at least one web application, and loaded concurrently with the first web application.

In 312, a second web application, such as element 106 of FIG. 1, may be loaded in a web browser. The operation of loading the second web application in the web browser may be similar to the operation of loading the first web application in the web browser. Similarly, the second web application, or the second web application may instead be newly installed, initialized, and/or executed for the purpose of running the second web application.

The second web application may be run in an instance of the web browser running in the same process or thread as the first web application, or the second web application may run as its own separate process or thread. In some embodiments, the second web application may instead be a completely program, such as a native application, with a different code base or software stack, as long as the applications involved have compatible APIs or other interfaces for cross-application messaging.

In 314, a second window of the web browser may be displayed. The operation of displaying the second window of the web browser may be similar to the operation of displaying the first window of the web browser. The second window of the web browser may be an instance of the web browser running in the same process or thread as the first window, or the second window may run as its own separate process or thread. In some embodiments, the second window of the web browser may instead be a completely different web browser program, with a different code base or software stack, as long as the browsers involved have compatible APIs or other interfaces for cross-application messaging.

In 316, the selected element is transmitted to the second web application from the first web application. This operation of transmitting the selected element may involve, on a back-end or underlying the transmission operation, copying (creating a copy) of the selected element's corresponding entry of the data corresponding to the first web application. For example, if the data corresponding to the first web application is a list of structured data entries, at least one for each element of the plurality of elements displayed, then transmitting the selected element may involve copying only the entry, in the list of structured data, corresponding to the selected element, from the first web application to the second web application.

In a further embodiment, the data corresponding to the selected element, after having been transmitted to the second web application, may be automatically removed from the data corresponding to the first web application. After having been transmitted to the second web application, the data corresponding to the selected element may be persistently stored, locally or remotely, or may reside in cache, possibly only on a temporary basis. Multiple instances of the data corresponding to the selected entry may be created.

In an exemplary embodiment, the selected element may be transmitted by way of a drag-and-drop operation between the first web application and the second web application, including a case of moving the selected element from the first window of the web browser and the second window of the web browser. This exemplary embodiment is depicted in FIG. 1. However, this operation of transmission may alternatively be carried out by a gesture, accelerometer input, text command, voice command, infrared port, wireless signal (including Bluetooth, NFC, RFID, Wi-Fi, etc.), API, or other interface, to name a few non-limiting examples.

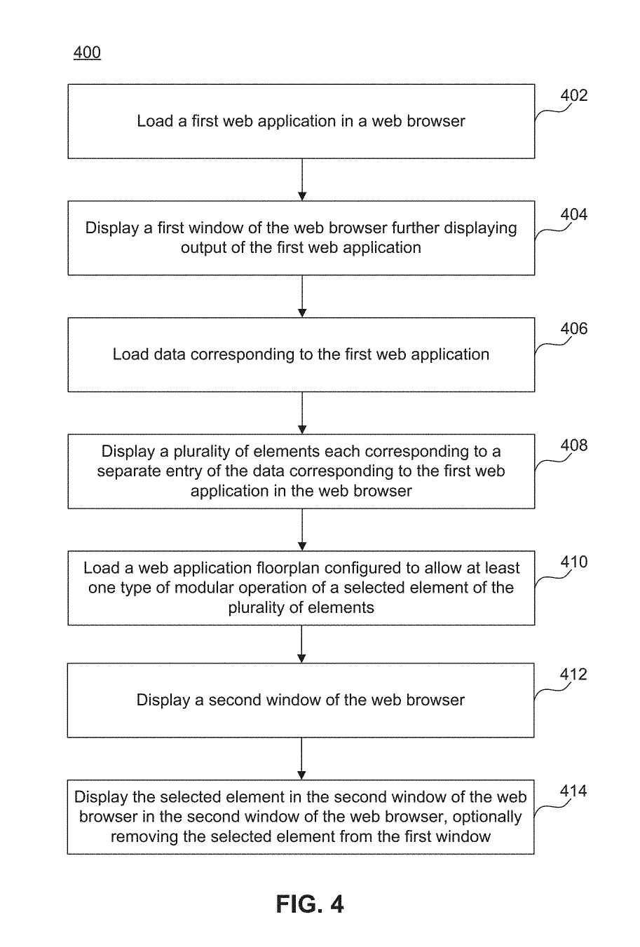

FIG. 4 shows process 400, illustrated by a flowchart illustrating a process for web application fragmentation, and specifically undocking, as behaviorally demonstrated in FIGS. 2A-2D. This process 400 may be used by or for any web application of the embodiments described herein that would have dockable or detachable components. Process 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Process 400 shall be described with reference to FIGS. 2A-2D. However, process 400 is not limited to that example embodiment.

In 402, a processor and memory, such as processor 504 and main memory 508 shown in FIG. 5, may load a first web application in a web browser. The first web application and/or web browser may already be running, including other web pages or applications already in memory, or the first web application and/or web browser may instead be newly installed, initialized, and/or executed for the purpose of running the first web application.

In 404, a first window of the web browser is displayed, for example, as element 202 of FIGS. 2A-2D. The first window of the web browser further displays output of the first web application. In displaying the first window of the web browser, the first window may be newly created for the first web application. In another exemplary embodiment, the first window may already be showing on a display, but in this case, “displaying” the first window will refer to selecting the first window of the web browser in which to proceed with further displaying the visible output of the first web application.

In 406, data corresponding to the first web application, for example, element 206A of FIGS. 2A-2D, may be loaded, such as into memory corresponding to the first web application as allocated through the web browser. In an exemplary embodiment, this data may be meaningful content of the first web application, such as database entries representing, for example, a contacts list, address book, accounting ledger, etc. One example of such information may be displayed in rows 1A, 2A, and 3A of the “Table 1” component 210A in FIGS. 2A-2D, and similarly in rows 1B, 2B, and 3B of the “Table 2” component 210B; other such examples may be the graphical representation of the map (streets, blocks, buildings, etc.) in the map component 208 of FIGS. 2A-2D or chat messages (SMS or instant message balloons) in the chat component 214 of FIGS. 2A-2D. In another embodiment, at least some of the data may be code for execution as a separate component of the web application, and data pertaining to that component. Examples of this would be independently executing components themselves, such as, in some embodiments, the map component 208, table components 210A-210B, navigation component (“nav component”) 212, or chat component 214, in the purely illustrative embodiment depicted in FIGS. 2A-2D.

In 408, a plurality of elements each corresponding to a separate entry of the data corresponding to the first web application may be displayed in the web browser. Here, the elements may be displayed and arranged according to various preferences of an end user, web developer, sitewide stylesheet, or other similar means. In some embodiments, at least one of the elements may be displayed as an independent component of the first web application, which may be docked, undocked, or redocked.

In 410, a web application floorplan may be loaded in such a way as to allow at least one type of modular operation of a selected element of the plurality of elements. This floorplan may be code, such as including various APIs and methods, which provide the web browser and/or web applications with capabilities such as application fragmentation and/or cross-application messaging. In some embodiments, this floorplan may be modular, and may be loaded before, during, or after the loading of the first web application or the web browser into memory. In other embodiments, the floorplan may be integrated with at least one web application, and loaded concurrently with the first web application.

In 412, a second web application, such as element 206B of FIGS. 2A, 2C, or 2D, may be loaded in a web browser, such as element 204 of FIGS. 2A, 2C, or 2D. The operation of loading the second web application in the web browser may be similar to the operation of loading the first web application in the web browser. Similarly, the second web application, or the second web application may instead be newly installed, initialized, and/or executed for the purpose of running the second web application. The second window of the web browser may be an instance of the web browser running in the same process or thread as the first window, or the second window may run as its own separate process or thread. In some embodiments, the second window of the web browser may instead be a completely different web browser program, with a different code base or software stack, as long as the browsers involved have compatible APIs or other interfaces for web application fragmentation.

In 414, the selected element may be displayed in the second window of the web browser in the second window of the web browser, such as map component 208 following the movement of the arrow overlay of FIG. 2A. Optionally, in a non-limiting exemplary embodiment, the selected element may be removed from the first window where it was displayed as part of the first web application. In another non-limiting example, the selected element as displayed in the second window of the web browser may be displayed as a sole element in the second web application as displayed in the second window of the web browser.

The reverse of this process is also possible, in a case where dockable or joinable components are separate, and a user wishes to join them. This reversed case may follow the above process 400 of unlocking components that were originally presented together in a web application, or it may instead be possible in other embodiments in which the elements began separately and were never before presented in a docked or joined configuration. Elements may be docked, undocked, and redocked, any number of times and in any configuration or arrangement, arbitrarily decided or within preconfigured specifications set by a system default, by a developer, or by an end user.

Additionally, configuration information and changes thereto may be generated by users, machines, or programs, using any number of interfaces such as APIs, protocols, or user tools, including text editors, web-based configuration front-ends, graphical configurators, voice input, environment sensors, etc.

Any applicable data structures, file formats, and schemas may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schernas may be used, either exclusively or in combination with known or open standards.

The data, files, and/or databases may be stored, retrieved, accessed, and/or transmitted in human-readable formats such as numeric, textual, graphic, or multimedia formats, as well as various types of markup language, among other possible formats. Alternatively or in combination with the above formats, the data, files, and/or databases may be stored, retrieved, accessed, and/or transmitted in binary, encoded, compressed, and/or encrypted formats, or any other machine-readable formats.

Interfacing or interconnection among various systems and layers may employ any number of mechanisms, such as any number of protocols, programmatic frameworks, floorplans, or application programming interfaces (API), including but not limited to Document Object Model (DOM), Discovery Service (DS), NSUserDefaults, Web Services Description Language (WSDL), Message Exchange Pattern (MEP), Web Distributed Data Exchange (WDDX), Web Hypertext Application Technology Working Group (WHATWG) HTML5 Web Messaging, Representational State Transfer (REST or RESTful web services), Extensible User Interface Protocol (XUP), Simple Object Access Protocol (SOAP), XML Schema Definition (XSD), XML Remote Procedure Call (XML-RPC), or any other mechanisms, open or proprietary, that may achieve similar functionality and results.

Such interfacing or interconnection may also make use of uniform resource identifiers (URI), which may further include uniform resource locators (URL) or uniform resource names (URN). Other forms of uniform and/or unique identifiers, locators, or names may be used, either exclusively or in combination with forms such as those set forth above.

Any of the above protocols or APIs may interface with or be implemented in any programming language, procedural, functional, or object-oriented, and may be compiled or interpreted. Non-limiting examples include C, C++, C#, Objective-C, Java, Swift, Go, Ruby, Perl, Python, JavaScript, WebAssembly, or virtually any other language, with any other libraries or schemas, in any kind of framework, runtime environment, virtual machine, interpreter, stack, engine, or similar mechanism, including but not limited to Node.js, V8, jQuery, Dojo, Dijit, OpenUI5, AngularJS, Express.js, Backbone.js, Ember.js, DHTMLX, React, among many other non-limiting examples.

Various embodiments may be implemented, for example, using one or more well-known computer systems, such as computer system 500 shown in FIG. 5. Computer system 500 may be used, for example, to implement process 300 of FIG. 3 and/or process 400 of FIG. 4. For example, computer system 500 may load a first web application in a web browser, display a first window of the web browser, the first window of the web browser further displaying output of the first web application, load data corresponding to the first web application, display a plurality of elements each corresponding to a separate entry of the data corresponding to the first web application in the web browser, load a web application floorplan configured to allow at least one type of modular operation of a selected element of the plurality of elements, and execute a modular operation of the selected element.

Computer system 500 includes one or more processors (also called central processing units, or CPUs), such as a processor 504. Processor 504 is connected to a communication infrastructure or bus 506.

Computer system 500 also includes user input/output device(s) 503, such as monitors, keyboards, pointing devices, etc., which communicate with communication infrastructure 506 through user input/output interface(s) 502.

One or more processors 504 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 also includes a main or primary memory 508, such as random access memory (RAM). Main memory 508 may include one or more levels of cache. Main memory 508 has stored therein control logic (i.e., computer software) and/or data.

Computer system 50( )may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to an exemplary embodiment, secondary memory 510 may include other means, instrumentalities or other approaches for allowing computer programs and/or other instructions and/or data to be accessed by computer system 500, Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system ⁵⁰( )may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

A computer system may also be any one of a personal digital assistant (PDA), desktop workstation, laptop or notebook computer, netbook, tablet, smart phone, smart watch, or embedded system, to name a few non-limiting examples.

Any such computer system 500 may run any type of application associated with a layered repository facility, including legacy applications, new applications, etc.

Computer system 500 may be a client or server, accessing or hosting any applications through any delivery paradigm, including but not limited to remote or distributed cloud computing solutions; local or on-premises software (“on-premise” cloud-based solutions); “as a service” models, e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), or infrastructure as a service (IaaS); or a hybrid model including any combination of the foregoing examples or other comparable services or delivery paradigms.

In an embodiment, a tangible apparatus or article of manufacture comprising a tangible computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use the configuration provider for layered repository using data processing devices, computer systems and/or computer architectures other than that shown in FIG. 5. In particular, embodiments may operate with software, hardware, and/or operating system implementations other than those described herein.

It is to be appreciated that the Detailed Description section, and not any other section, is intended to be used to interpret the claims. Other sections may set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method of executing web applications in a web browser, comprising:
loading, by at least one processor, a first web application in a web browser;
displaying, by the at least one processor, a first window of the web browser, wherein the first window of the web browser further displays output of the first web application;
loading, by the at least one processor, data corresponding to the first web application;
displaying, by the at least one processor, a plurality of elements each corresponding to a separate entry of the data corresponding to the first web application in the web browser;
loading, by the at least one processor, a web application floorplan configured to allow at least one type of a modular operation of a selected element of the plurality of elements; and
executing, by the at least one processor, the modular operation of the selected element.

2. The method of claim 1, further comprising:
displaying, by the at least one processor, a second window of the web browser; and
wherein the modular operation of the selected element comprises displaying the selected element in the second window of the web browser in the second window of the web browser.

3. The method of claim 2, further comprising:
automatically removing, by the at least one processor, the selected element from being displayed in the first window of the web browser.

4. The method of claim 2, further comprising:
rejoining to the first web application, in the first window of the web browser, by the at least one processor, the selected element displayed in the second window of the web browser.

5. The method of claim 1, further comprising:
loading, by the at least one processor, a second web application in a web browser;
displaying, by the at least one processor, a second window of the web browser;
wherein at least one element of the plurality of elements comprises a web application component; and
wherein the modular operation of the selected element comprises transmitting, by the at least one processor, the selected element, to the second web application.

6. The method of claim 5, wherein the transmitting comprises transmitting the selected element from the first web application to the second web application via a cross-application messaging application programming interface, and wherein the transmitting further comprises creating, by the at least one processor, in data corresponding to the second web application, a copy of the selected element's corresponding entry of the data corresponding to the first web application.

7. The method of claim 5, wherein the selected element is transmitted from the first web application to the second web application via a drag-and-drop operation on the selected element from the first window of the web browser to the second window of the web browser.

8. A system, comprising:
a memory; and
at least one processor coupled to the memory and configured to:
load a first web application in a web browser;
display a first window of the web browser, wherein the first window of the web browser further displays output of the first web application;
load data corresponding to the first web application;
display a plurality of elements each corresponding to a separate entry of the data corresponding to the first web application in the web browser;
load a web application floorplan configured to allow at least one type of a modular operation of a selected element of the plurality of elements; and
execute the modular operation of the selected element.

9. The system of claim 8, wherein the at least one processor is further configured to display a second window of the web browser; and wherein the modular operation of the selected element comprises displaying the selected element in the second window of the web browser in the second window of the web browser.

10. The system of claim 9, wherein the at least one processor is further configured to:
rejoin to the first web application, in the first window of the web browser, the selected element displayed in the second window of the web browser.

11. The system of claim 8, wherein the at least one processor is further configured to:
load a second web application in a web browser;
display a second window of the web browser;
wherein at least one element of the plurality of elements comprises a web application component; and
wherein the modular operation of the selected element comprises transmitting the selected element, to the second web application.

12. The system of claim 11, wherein the transmitting comprises transmitting the selected element from the first web application to the second web application via a cross-application messaging application programming interface, and wherein the transmitting further comprises creating, in data corresponding to the second web application, a copy of the selected element's corresponding entry of the data corresponding to the first web application.

13. The system of claim 11, wherein the selected element is transmitted from the first web application to the second web application via a drag-and-drop operation on the selected element from the first window of the web browser to the second window of the web browser.

14. A non-transitory computer-readable device having instructions stored thereon that, when executed by at least one computing device, causes the at least one computing device to perform operations comprising:
loading a first web application in a web browser;
displaying a first window of the web browser, wherein the first window of the web browser further displays output of the first web application;
loading data corresponding to the first web application;
displaying a plurality of elements each corresponding to a separate entry of the data corresponding to the first web application in the web browser;
loading a web application floorplan configured to allow at least one type of a modular operation of a selected element of the plurality of elements; and
executing the modular operation of the selected element.

15. The non-transitory computer-readable device of claim 14, the operations further comprising:
displaying a second window of the web browser; and
wherein the modular operation of the selected element comprises displaying the selected element in the second window of the web browser in the second window of the web browser.

16. The non-transitory computer-readable device of claim 15, the operations further comprising:
automatically removing the selected element from being displayed in the first window of the web browser.

17. The non-transitory computer-readable device of claim 15, the operations further comprising:
rejoining to the first web application, in the first window of the web browser the selected element displayed in the second window of the web browser.

18. The non-transitory computer-readable device of claim 14, the operations further comprising:
loading a second web application in a web browser;
displaying a second window of the web browser;
wherein at least one element of the plurality of elements comprises a web application component; and
wherein the modular operation of the selected element comprises transmitting, by the at least one processor, the selected element, to the second web application.

19. The non-transitory computer-readable device of claim 18, wherein the transmitting comprises transmitting the selected element is transmitted from the first web application to the second web application via a cross-application messaging application programming interface, and wherein the transmitting further comprises creating, by the at least one processor, in data corresponding to the second web application, a copy of the selected element's corresponding entry of the data corresponding to the first web application.

20. The non-transitory computer-readable device of claim 18, wherein the selected element is transmitted from the first web application to the second web application via a drag-and-drop operation on the selected element from the first window of the web browser to the second window of the web browser.
